(19) United States
(12) Patent Application Publication
(10) Pub. No.: US 2025/0360555 A1
(43) Pub. Date: Nov. 27, 2025

(54) ADJUSTMENT DEVICE OF A THREAD ROLLING MACHINE

(71) Applicant: CHUAN YI SHENG MACHINERY CO., LTD., KAOHSIUNG CITY (TW)

(72) Inventor: MING-YI HSIAO, KAOHSIUNG CITY (TW)

(21) Appl. No.: 18/673,720

(22) Filed: May 24, 2024

(51) Int. Cl. B21H 3/04; F16H 1/16

(52) U.S. Cl. CPC B21H 3/046; F16H 1/16

(57) ABSTRACT

An adjustment device is connected to a transmission device of a thread rolling machine. The transmission device includes an eccentric wheel and a transmission shaft. The adjustment device includes a drive assemblage and a worm assemblage linked with the transmission shaft. The worm assemblage includes a worm shaft meshed with the drive assemblage and a regulating unit disposed on the worm shaft. The drive assemblage includes a first drive unit disposed on a first shaft end of the transmission shaft and defining a positioning portion whose center is situated away from a center of the first drive unit to present an eccentric arrangement. Accordingly, the cooperation between the drive assemblage and the worm assemblage allows a thread-rolling distance applied to the thread rolling machine to be easily and precisely adjusted.

### BACKGROUND OF THE INVENTION

### 1. Field of the Invention

This invention relates to a thread rolling machine and relates particularly to an adjustment device of a thread rolling machine.

### 2. Description of the Related Art

Referring to FIGS. 1, 1A, and 2, a conventional thread rolling machine 1 comprises a base 11, a feeding track 12 and transmission device 13 respectively installed on the base 11, a thread rolling device 14 driven by the transmission device 13, and a regulating assemblage 15 installed on the transmission device 13. The transmission device 13 has a transmission wheel 131 installed on the base 11, an eccentric wheel 132 linked with the transmission wheel 131, and a transmission shaft 133 linked with the eccentric wheel 132. The transmission shaft 133 has a first shaft end 133A connected to the eccentric wheel 132, a second shaft end 133B connected to the thread rolling device 14, and a through hole H1 formed through the first shaft end 133A. The regulating assemblage 15 has a first regulating unit 151 mounted on the first shaft end 133A, a second regulating unit 152 disposed beside the first shaft end 133A and engaged with the first regulating unit 151, an opening 153 formed through the first regulating unit 151, and a third regulating unit 154 meshed with the second regulating unit 152. A center of the opening 153 is formed away from a center of the first regulating unit 151 so that the eccentric wheel 132 is eccentrically installed when the eccentric wheel 132 is inserted into the opening 153 and engaged with the first regulating unit 151. The thread rolling device 14 has a first die unit 141 installed on the base 11 and a second die unit 142 facing the first die unit 141 and connected to the second shaft end 133B of the transmission shaft 133.

During a thread-rolling operation of the thread rolling machine 1, the feeding track 12 is adapted to deliver a plurality of workpieces 2. Simultaneously, a rotation of the eccentric wheel 132 is carried out by a rotation of the transmission wheel 131 so that the transmission shaft 133 is driven by the rotation of the eccentric wheel 132 to thereby attain a forward and backward movement. The second die unit 142 is synchronously driven by the transmission shaft 133 to slide along the first die unit 141 so that each workpiece 2 is rolled by the first die unit 141 and the second die unit 142 to form a plurality of threads (not shown) correspondingly. Thus, the thread-rolling operation is completed.

Referring to FIGS. 1, 2 and 3, before the thread-rolling operation is conducted by the thread rolling machine 1, a thread-rolling distance applied to the thread rolling machine 1 should be adjusted according to the size of different workpieces 2 so that each workpiece 2 can be processed precisely. First, the third regulating unit 154 is rotated to carry out a rotation of the second regulating unit 152. The first regulating unit 151 is synchronously driven by the rotation of the second regulating unit 152 to be rotated, thereby changing a position of the opening 153 and thence changing a distance D1 defined between the second die unit 142 and the opening 153. When the distance D1 is extended, the thread-rolling distance is shortened so that the workpiece 2 is rolled for a shorter time between the first die unit 141 and the second die unit 142. On the contrary, When the distance D1 is shortened, the thread-rolling distance is extended so that the workpiece 2 is rolled for a longer time between the first die unit 141 and the second die unit 142, thereby executing the thread-rolling operation properly according to different workpieces 2.

However, an outer diameter of the third regulating unit 154 is much smaller than an outer diameter of the second regulating unit 152, and therefore a larger force should be applied to the third regulating unit 154 in order to carry out the rotation of the second regulating unit 152 through the third regulating unit 154, and that is laborious and inconvenient. Further, the third regulating unit 154 and the second regulating unit 152 are meshed to each other through a plurality of threaded units 155. If the threaded units 155 disposed on the third regulating unit 154 are smaller than the threaded units 155 disposed on the second regulating unit 152, the third regulating unit 154 may not be capable of carrying out the rotation of the second regulating unit 152 because the strength of the threaded units 155 of the third regulating unit 154 is not enough for bearing the force. In order to maintain the strength of the threaded units 155 of the third regulating unit 154, the volume of the threaded units 155 is increased, and that restricts the number of the threaded units 155 because of the small outer diameter of the third regulating unit 154. Meanwhile, it is also difficult to adjust the thread-rolling distance applied to the thread rolling machine 1 easily and precisely, and that requires to be improved.

### SUMMARY OF THE INVENTION

The object of this invention is to provide an adjustment device of a thread rolling machine capable of adjusting a thread-rolling distance applied to the thread rolling machine easily and precisely.

The adjustment device is installed on the thread rolling machine. The thread rolling machine includes a base, a feeding track and a transmission device respectively installed on the base, and a thread rolling device connected to the transmission device. The transmission device has a transmission wheel installed on the base, an eccentric wheel linked with the transmission wheel, and a transmission shaft linked with the eccentric wheel. The transmission shaft has a first shaft end connected to the eccentric wheel, a through hole formed through the first shaft end, and a second shaft end connected to the thread rolling device. The thread rolling device has a first die unit installed on the base and a second die unit connected to the second shaft end of the transmission shaft and facing the first die unit. The adjustment device of this invention comprises a housing installed on the first shaft end, a drive assemblage installed on the first shaft end, and a worm assemblage installed on the housing. The worm assemblage has a worm shaft installed on the housing and meshed with the drive assemblage, an engagement portion installed on an outer periphery of the worm shaft, and a regulating unit rotatably installed on the worm shaft. The drive assemblage has a first drive unit installed on one side of the first shaft end, a positioning portion defined on the first drive unit, a second drive unit installed on another side of the first shaft end, and a linking portion meshed with the engagement portion. The first drive unit and the second drive unit are situated beside and engaged to each other. The eccentric wheel is engaged with the positioning portion while the positioning portion is accommodated in the through hole of the first shaft end. A center of the positioning portion is situated away from a center of the first drive unit, thereby presenting an eccentric arrangement of the eccentric wheel. Thus, the regulating unit is adapted to adjust a rotation of the worm shaft so that a rotation of the drive assemblage is driven by the rotation of the worm shaft, and thus a position of the positioning portion within the through hole is changed, thereby adjusting a distance defined between the second die unit and the positioning portion easily and precisely so that the thread-rolling distance is adjusted correspondingly in order to process workpieces with different sizes properly. The worm shaft and the regulating unit facilitate a slight rotation of the drive assemblage, thereby achieving a slight and precise adjustment in the thread-rolling distance and saving the effort for executing the adjustment.

Preferably, the linking portion is disposed on an outer periphery of the second drive unit.

Preferably, the linking portion is disposed on an outer periphery of the first drive unit.

Preferably, a bearing unit is disposed between the positioning portion and the eccentric wheel.

Preferably, the first drive unit is fastened to the second drive unit by using a plurality of fastening units.

Preferably, at least one connecting unit is disposed between the first drive unit and the second drive unit, thereby achieving a synchronous rotation of the first drive unit and the second drive unit.

Preferably, the connecting unit is a rivet.

### BRIEF DESCRIPTION OF THE DRAWINGS

FIG. 1 is a schematic view showing a conventional thread rolling machine;

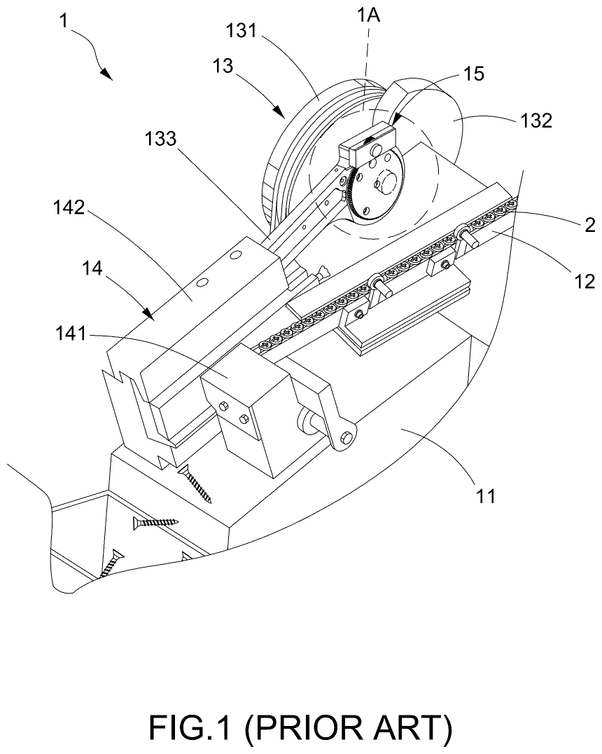

FIG. 1A is an enlarged view of the encircled portion 1A indicated in FIG. 1;

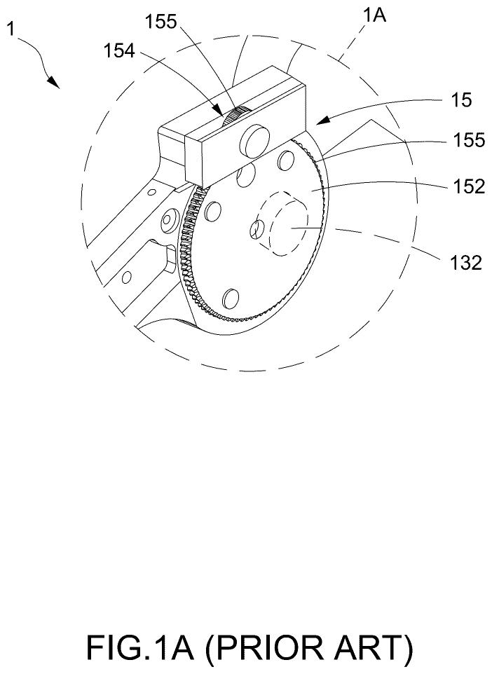

FIG. 2 is an exploded view showing partial elements of the conventional thread rolling machine;

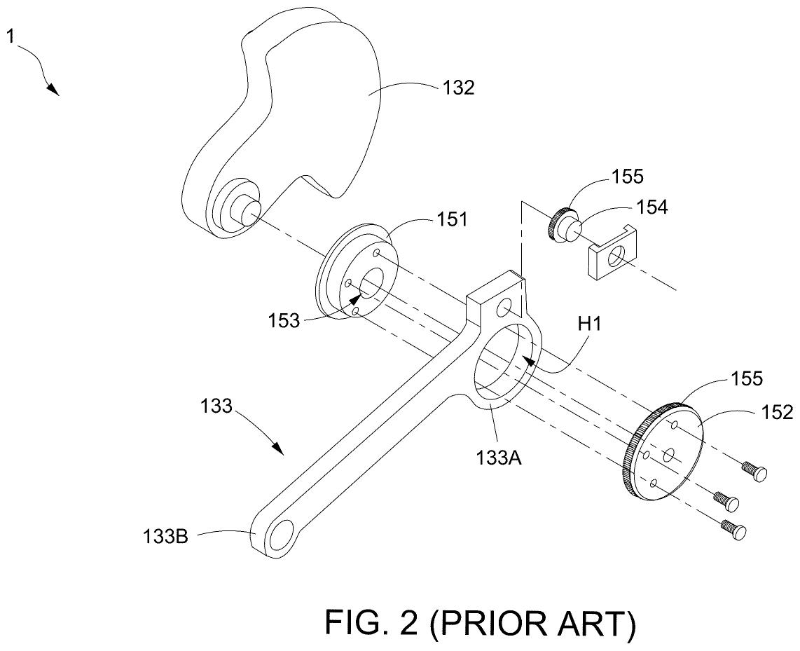

FIG. 3 is a schematic view showing an adjusting operation of the conventional thread rolling machine;

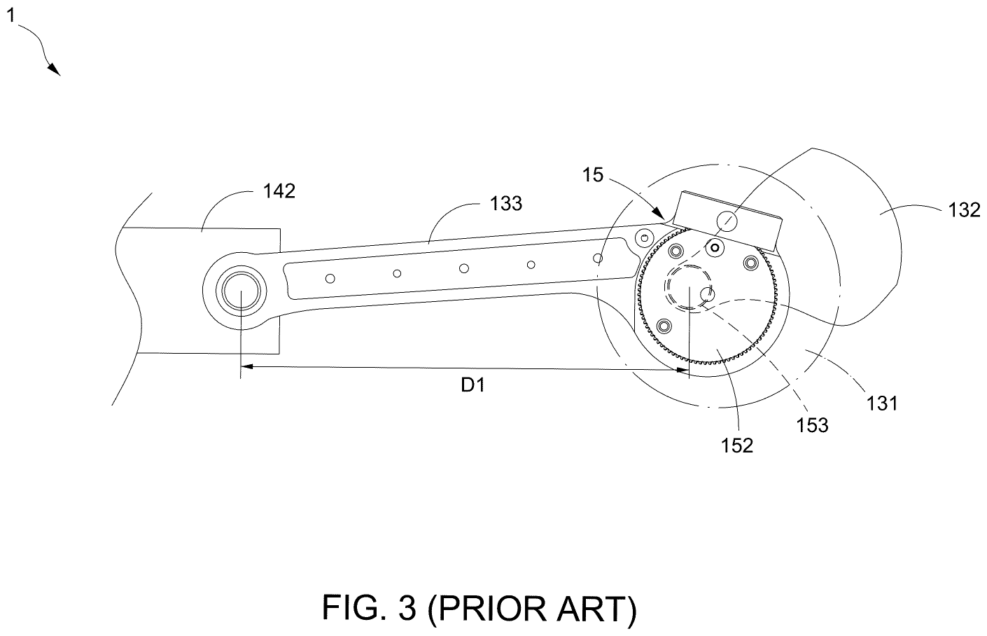

FIG. 4 is a perspective view showing a first preferred embodiment of this invention;

FIG. 4A is an enlarged view of the encircled portion 4A indicated in FIG. 4;

FIG. 5 is an exploded view showing the first preferred embodiment of this invention;

FIGS. 6-7 are schematic views showing an adjusting operation of the first preferred embodiment of this invention;

FIG. 8 is an exploded view showing a second preferred embodiment of this invention characterized in that the linking portion is disposed on the first drive unit;

FIGS. 9-10 are schematic views showing an adjusting operation of the second preferred embodiment of this invention; and

FIG. 11 is a schematic view showing a third preferred embodiment of this invention characterized in that at least one connecting unit is disposed between the first drive unit and the second drive unit.

### DETAILED DESCRIPTION OF THE PREFERRED EMBODIMENTS

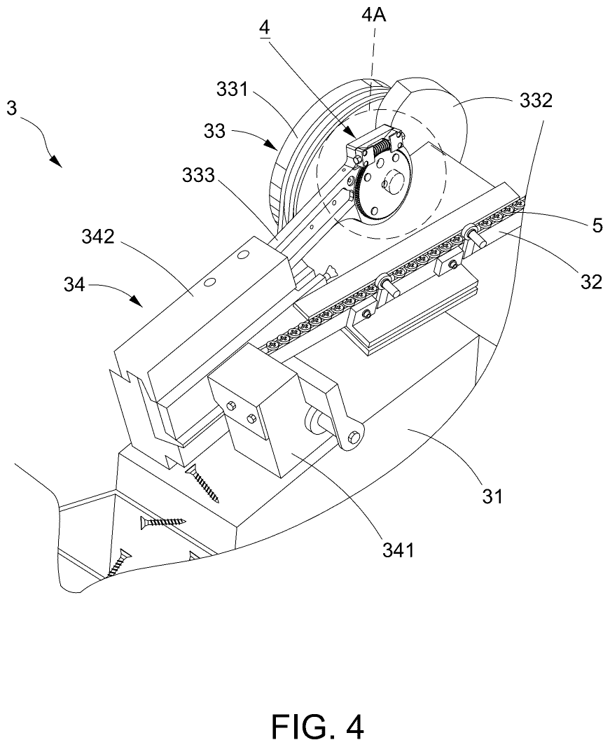

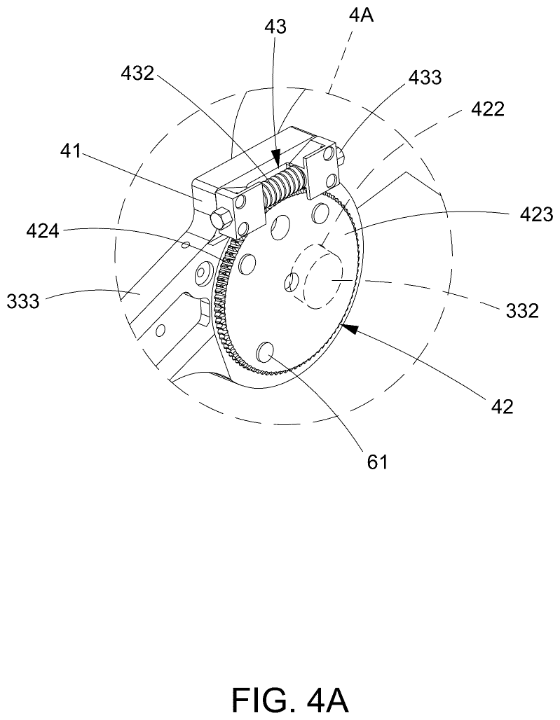

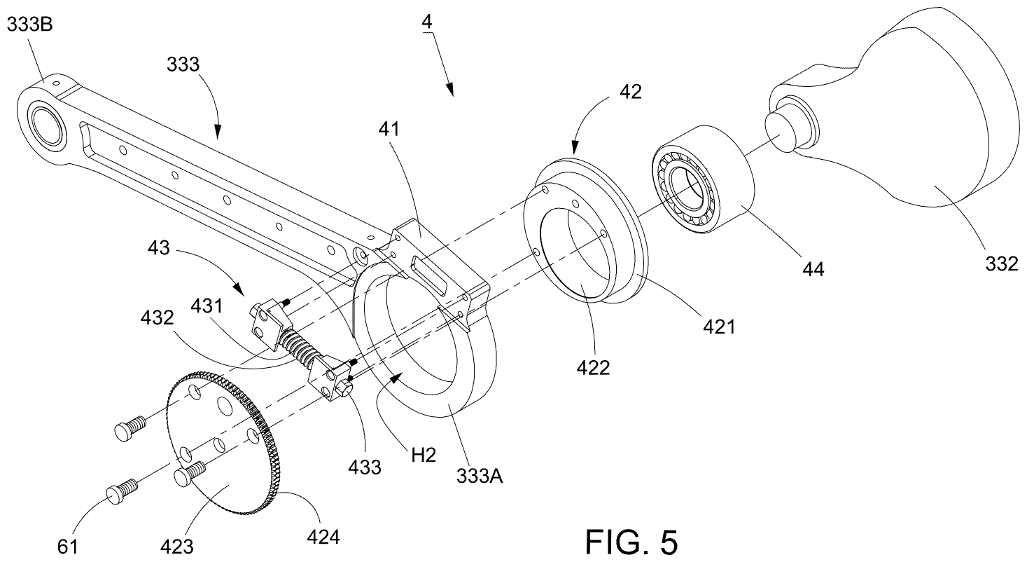

Referring to FIGS. 4, 4A and 5, a first preferred embodiment of an adjustment device 4 of a thread rolling machine 3 of this invention is disclosed. The adjustment device 4 is disposed on the thread rolling machine 3. The thread rolling machine 3 comprises a base 31, a feeding track 32 installed on the base 31 and adapted to deliver a plurality of workpieces 5, a transmission device 33 installed on the base 31 and relative to the feeding track 32, and a thread rolling device 34 connected to and driven by the transmission device 33. The adjustment device 4 is connected to the transmission device 33. The transmission device 33 includes a transmission wheel 331 disposed on the base 31, an eccentric wheel 332 linked with the transmission wheel 331, and a transmission shaft 333 linked with the eccentric wheel 332. The transmission shaft 333 has a first shaft end 333A connected to the eccentric wheel 332, a through hole H2 formed through the first shaft end 333A, and a second shaft end 333B connected to the thread rolling device 34. The first shaft end 333A and the second shaft end 333B are opposite to each other. The thread rolling device 34 includes a first die unit 341 disposed on the base 31 and a second die unit 342 facing the first die unit 341. The second die unit 342 is connected to the second shaft end 333B of the transmission shaft 333 so that the second die unit 342 is driven by the transmission shaft 333 to thereby movably slide along the first die unit 341.

Referring to FIGS. 4A and 5, the adjustment device 4 includes a housing 41 mounted on the first shaft end 333A of the transmission shaft 333, a drive assemblage 42 installed on the first shaft end 333A of the transmission shaft 333, and a worm assemblage 43 installed on the housing 41 and relative to the drive assemblage 42 so that the worm assemblage 43 is capable of controlling a rotation of the drive assemblage 42. The worm assemblage 43 has a worm shaft 431 disposed on the housing 41 and meshed with the drive assemblage 42, an engagement portion 432 formed along an outer periphery of the worm shaft 431, and a regulating unit 433 extending outwards from one side of the worm shaft 431 and rotatably installed on the worm shaft 431. The regulating unit 433 can be disposed on both sides of the worm shaft 431 according to needs. The regulating unit 433 is adapted to adjust and control a rotation of the worm shaft 431. The drive assemblage 42 has a first drive unit 421 installed on the first shaft end 333A of the transmission shaft 333, a positioning portion 422 defined on the first drive unit 421 and engaged with the eccentric wheel 332, a second drive unit 423 installed beside the first shaft end 333A of the transmission shaft 333 and facing the first drive unit 421, and a linking portion 424 formed along an outer periphery of the second drive unit 423 and meshed with the engagement portion 432. In this preferred embodiment, the first drive unit 421 is fixed to the second drive unit 423 by using a plurality of fastening units 61. The fastening units 61 penetrate through the second drive unit 423 to be engaged with the first drive unit 421 so that the second drive unit 423 is pressed and tightened by the fastening units 61, thereby achieving a tight engagement of the first drive unit 421 and the second drive unit 423. A center of the positioning portion 422 is situated away from a center of the first drive unit 421 so that the eccentric wheel 332 is eccentrically installed. The positioning portion 422 is accommodated in the through hole H2 of the first shaft end 333A. Thus, a distance D2 defined between the second die unit 342 and the positioning portion 422 can be adjusted through a rotation of the first drive unit 421 carried out by the worm assemblage 43. In this preferred embodiment, a bearing unit 44 is disposed between the positioning portion 422 and the eccentric wheel 332, thereby preventing the improper friction caused between the positioning portion 422 and the eccentric wheel 332.

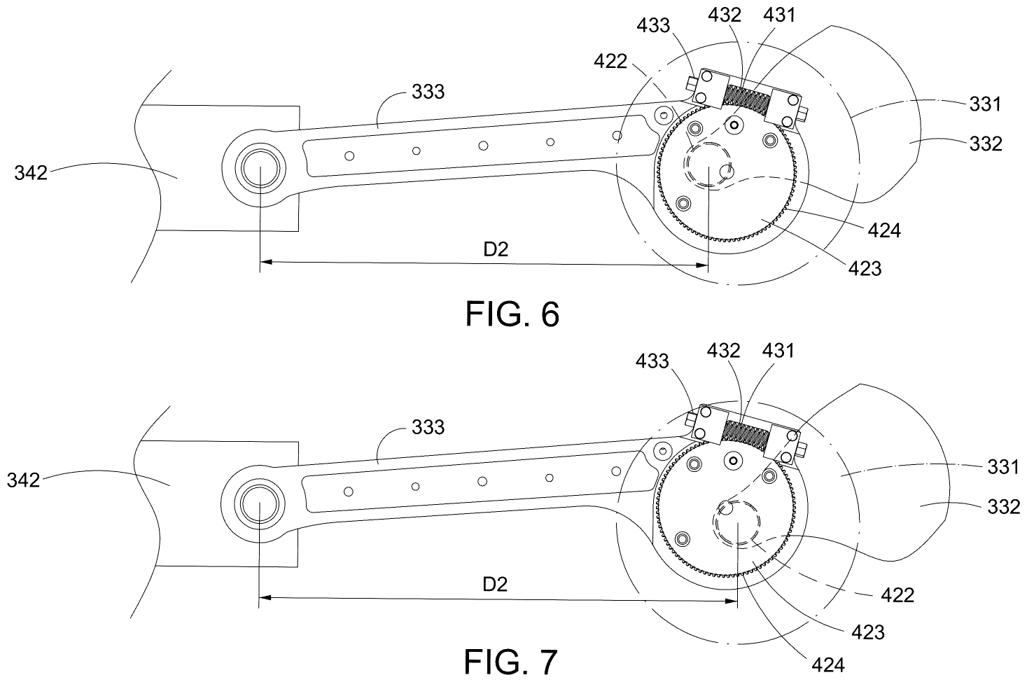

Referring to FIGS. 5, 6 and 7, before a thread-rolling operation is conducted by the thread rolling machine 3, an adjusting operation for regulating the distance D2 between the second die unit 342 and the positioning portion 422 should be executed according to the size of the workpieces 5 aimed to be processed, thereby changing the thread-rolling distance applied to the thread rolling machine 3. The thread-rolling distance is a distance defined when each workpiece 5 is carried by the second die unit 342 to be rolled between the first die unit 341 and the second die unit 342. Because the first drive unit 421 and the second drive unit 423 are tightly fastened through the fastening units 61 to allow the transmission shaft 333 to be fixed between the first drive unit 421 and the second drive unit 423, the fastening units 61 should be loosened slightly in order to executing the adjusting operation, namely to extend or shorten the thread-rolling distance. When the fastening units 61 are loosened, the fastening units 61 are still engaged with the first drive unit 421. Meanwhile, the second drive unit 423 which is situated between the fastening units 61 and the first drive unit 421 is not tightened by the fastening units 61 so that the second drive unit 423 is rotatable. Thus, the first drive unit 421 and the second drive unit 423 are not fixed to the transmission shaft 333 and capable of being rotated. After that, through rotating the regulating unit 433, the worm shaft 431 is driven to be rotated. A rotation of the second drive unit 423 is then carried out by the rotation of the worm shaft 431 owing to the engagement of the engagement portion 432 and the linking portion 424. Meanwhile, the first drive unit 421 is synchronously rotated under the rotation of the second drive unit 423 because the rotation of the first drive unit 421 allows the first drive unit 421 to push the fastening units 61 so that the second drive unit 423 is driven by the first drive unit 421 through the fastening units 61. Thus, a position of the positioning portion 422 within the through hole H2 is changed, thereby changing the distance D2 between the second die unit 342 and the positioning portion 422 and further changing the thread-rolling distance applied to the thread rolling machine 3. When the distance D2 is shortened, the thread-rolling distance is extended so that the workpiece 5 is rolled for a longer time between the first die unit 341 and the second die unit 342, and that is preferable for processing the workpieces 5 which are provided with a larger outer diameter.

On the contrary, when the distance D2 is extended, the thread- rolling distance is shortened so that the workpiece 5 is rolled for a shorter time between the first die unit 341 and the second die unit 342, and that is preferable for processing the workpieces 5 which are provided with a smaller outer diameter. Thus, the adjusting operation is conducted by rotating the regulating unit 433 to thereby achieve the cooperation n between the drive assemblage 42 and the worm assemblage 43, and that saves the effort for executing the adjusting operation. Meanwhile, the worm shaft 431 and the engagement portion 432 can bear the force caused during the adjusting operation effectively and facilitate a slight rotation of the second and the first drive units 423, 421, thereby achieving a slight and precise adjustment in the distance D2 and the thread-rolling distance.

After the adjusting operation is completed, the fastening units 61 are fastened tightly so that the second and the first drive units 423, 421 are fixed to the transmission shaft 333. Namely, the second and the first drive units 423, 421 are fixed and immovable. Then, the eccentric wheel 332 is driven by the transmission wheel 331 to be rotated. The rotation of the eccentric 20 wheel 332 then carries out the reciprocating forward and backward movement of the transmission shaft 333 so that the second die unit 342 is driven by the transmission shaft 333 to slide along the first die unit 341. Meanwhile, each workpiece 5 is delivered and situated between the first die unit 341 and the second die unit 342 along the feeding track 32, and then rolled by the first die unit 341 and the second die unit 342 to form a plurality of threads (not shown). Thus, the thread-rolling operation is completed.

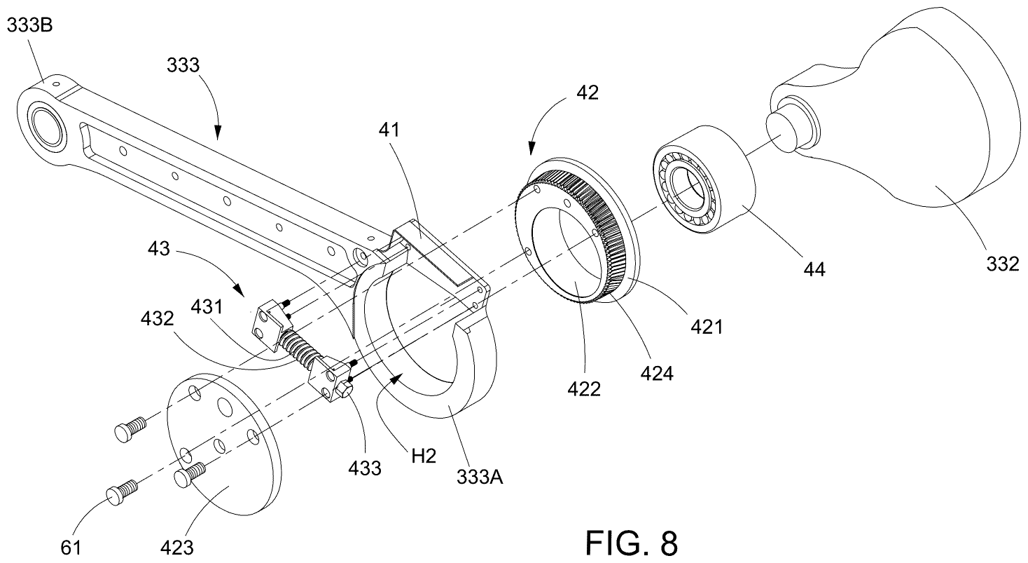

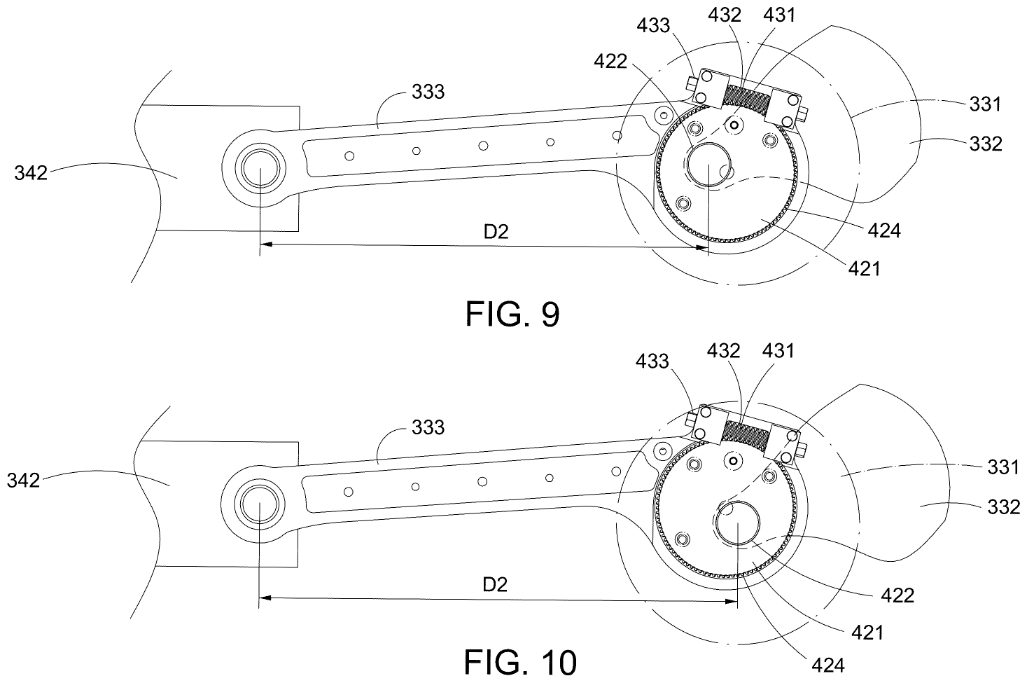

Referring to FIGS. 8, 9 and 10 show a second preferred embodiment of the adjustment device 4 of this invention. The correlated elements and the concatenation of elements, the operation and objectives of the second preferred embodiment are the same as those of the first preferred embodiment. This embodiment is characterized in that the linking portion 424 is formed along an outer periphery of the first drive unit 421. The worm shaft 431 is disposed within the housing 41 so that the engagement portion 432 formed on the worm shaft 431 is meshed with the linking portion 424 formed on the first drive unit 421. Thus, after the fastening units 61 are slightly released to allow the first and the second drive units 421, 423 to be rotatable, the rotation of the worm shaft 431 is carried out by rotating the regulating unit 433 whereby the first drive unit 421 is driven to be rotated under the rotation of the worm shaft 431 owing to the engagement of the engagement portion 432 and the linking portion 424, thereby changing the position of the positioning portion 422 within the through hole H2 and thence changing the distance D2 between the second die unit 342 and the positioning portion 422. Hence, the thread-rolling distance applied to the thread rolling machine 3 is adjusted precisely and properly. Because the first drive unit 421 is driven by the worm assemblage 43 directly, the adjusting operation is also simplified.

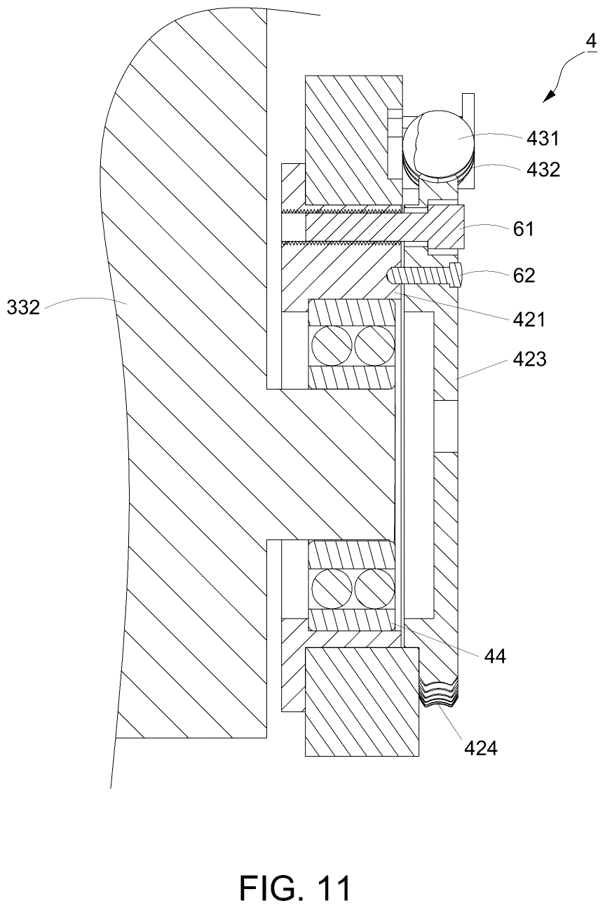

Referring to FIG. 11 shows a third preferred embodiment of the adjustment device 4 of this invention. The correlated elements and the concatenation of elements, the operation and objectives of the third preferred embodiment are the same as those of the first preferred embodiment. This embodiment is characterized in that at least one connecting unit 62 is installed between the first drive unit 421 and the second drive unit 423. The connecting unit 62 is respectively connected to the first drive unit 421 and the second drive unit 423 so that the first drive unit 421 and the second drive unit 423 are capable of being synchronously rotated. Here takes an example that the connecting unit 62 is a rivet. Thus, after the fastening units 61 are slightly loosened to allow the first and the second drive units 421, 423 to be rotatable, the worm shaft 431 is rotated under a rotation of the regulating unit 433 (not shown) to further carry out a rotation of the second drive unit 423. Owing to the connecting unit 62, the first drive unit 421 is driven immediately by the second drive unit 423 to be rotated whereby the rotation of the first drive unit 421 is carried out without delay. Further, because the rotation of the first drive unit 421 is not carried out by pressing the fastening units 61, a tolerance for processing holes (not shown) of the second drive unit 423 that are adapted for the insertion of the fastening units 61 is increased, thereby saving the time and costs for manufacturing the second drive unit 423.

To sum up, the adjustment device of this invention takes advantages that the worm assemblage has the worm shaft, the regulating unit adapted to control the worm shaft, and the engagement portion disposed on the worm shaft. The drive assemblage has the first drive unit defining the positioning portion which is engaged with the eccentric wheel, the second drive unit engaged with the first drive unit, and the linking portion meshed with the engagement portion. The center of the positioning portion is away from the center of the first drive unit so that the eccentric wheel is eccentrically disposed. Thus, the worm shaft is rotated under a rotation of the regulating unit. The drive assemblage is then driven by the rotation of the worm shaft to be rotated, thereby changing the position of the positioning portion and adjusting the distance defined between the second die unit and the positioning portion whereby the thread-rolling distance applied to the thread rolling machine is adjusted easily and precisely in order to process the workpieces with different sizes properly.

While the embodiments of this invention are shown and described, it is understood that further variations and modifications may be made without departing from the scope of this invention.

What is claimed is:

1. An adjustment device of a thread rolling machine, said adjustment device being installed on said thread rolling machine, said thread rolling machine comprising a base, a feeding track and a transmission device respectively disposed on said base, and a thread rolling device driven by said transmission device, said adjustment device being connected to said transmission device, wherein said transmission device includes a transmission wheel disposed on said base, an eccentric wheel linked with said transmission wheel, and a transmission shaft linked with said eccentric wheel and having opposite first and second shaft ends, with a through hole formed through said first shaft end, said thread rolling device including a first die unit disposed on said base and a second die unit facing said first die unit and connected to said second shaft end of said transmission shaft;
wherein said adjustment device includes a housing disposed on said first shaft end of said transmission shaft, a drive assemblage disposed on said first shaft end of said transmission shaft, and a worm assemblage disposed on said housing and adapted to adjust a rotation of said drive assemblage, said worm assemblage including a worm shaft disposed on said housing and meshed with said drive assemblage, an engagement portion disposed on an outer periphery of said worm shaft, and a regulating unit rotatably disposed on one side of said worm shaft so that a rotation of said worm shaft is driven by a rotation of said regulating unit, said drive assemblage including a first drive unit mounted on said first shaft end and defining a positioning portion engaged with said eccentric wheel, a second drive unit disposed beside said first shaft end and engaged with said first drive unit, and a linking portion meshed with said engagement portion, a center of said positioning portion being away from a center of said first drive unit so that said eccentric wheel is eccentrically disposed, said positioning portion being accommodated in said through hole of said first shaft end, said worm shaft being rotated under said rotation of said regulating unit to carry out said rotation of said drive assemblage, thereby changing a position of said positioning portion within said t hole and thence adjusting a distance defined between said second die unit and said positioning portion.

2. The adjustment device according to claim 1, wherein said linking portion is disposed on an outer periphery of said second drive unit.

3. The adjustment device according to claim 1, wherein said linking portion is disposed on an outer periphery of said first drive unit.

4. The adjustment device according to claim 1, wherein a bearing unit is disposed between said positioning portion and said eccentric wheel.

5. The adjustment device according to claim 1, wherein said first drive unit is fastened to said second drive unit by using a plurality of fastening units.

6. The adjustment device according to claim 1, wherein at least one connecting unit is disposed between said first drive unit and said second drive unit, thereby achieving a synchronous rotation of said first drive unit and said second drive unit.

7. The adjustment device according to claim 6, wherein said at least one connecting unit is a rivet.
